(19) United States
(12) Patent Application Publication
(10) Pub. No.: US 2025/0221804 A1
(43) Pub. Date: Jul. 10, 2025

(54) DENTAL FLOSS DEVICE

(71) Applicant: Verlin Kelly, Summerfield, FL (US)

(72) Inventor: Verlin Kelly, Summerfield, FL (US)

(21) Appl. No.: 18/980,136

(22) Filed: Dec. 13, 2024

Related U.S. Application Data
(60) Provisional application No. 63/617,899, filed on Jan. 5, 2024.

(51) Int. Cl. A61C 15/04

(52) U.S. Cl. CPC A61C 15/041; A61C 15/043

(57) ABSTRACT

The subject matter disclosed and claimed herein, in one embodiment thereof, comprises a dental floss device. The device is comprised of a dental floss with a looped design that facilitates access to difficult-to-reach areas, particularly at the back of the mouth. The design also enables for improved grip and control during use. The floss of the device is waxed enabling it to remove plaque and debris. Additionally, the device is comprised of a circular body or band that encourages correct finger placement, thus enhancing maneuverability. Thus, the dental floss device provides a greatly improved flossing experience.

### CROSS-REFERENCE TO RELATED APPLICATION

The present application claims priority to, and the benefit of, U.S. Provisional Application No. 63/617,899, which was filed on Jan. 5, 2024, and is incorporated herein by reference in its entirety.

### FIELD OF THE INVENTION

The present invention relates generally to the field of dental floss devices. More specifically, the present invention relates to dental floss with a looped design that facilitates access to difficult-to-reach areas, particularly at the back of the mouth. The device also comprises a dispenser. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in dental floss devices. Generally, when using traditional string floss, it can be difficult to get in-between the teeth. This is especially true in the back of the mouth.

Accordingly, there is a demand for an improved dental floss device. More particularly, there is a demand for a dental floss device that more easily facilitates flossing in the back of the mouth.

Therefore, there exists a long felt need in the art for an improved flossing device. There is also a long felt need in the art for a dental floss device. Finally, there is a long felt need in the art for a dental floss device that enables a user to easily floss between teeth and between teeth at the back of their mouth.

The subject matter disclosed and claimed herein, in one embodiment thereof, comprises a dental floss device. The dental floss device comprises a dental floss that is configured in a looped (i.e., closed loop or band) or circular shape that facilitates access to difficult-to-reach areas, particularly at the back of the mouth. The floss having a width from about 1 mm to about 4 mm and features a wax coating that enables it to remove plaque and debris from in between the teeth. The circular design of the floss encourages correct finger placement, enhancing maneuverability. Thus, the dental floss device provides a greatly improved flossing experience. Accordingly, the device enables users to floss their teeth in a quick and easy manner.

In this manner, the dental floss device of the present invention accomplishes all of the forgoing objectives and provides users with a device that enables for an easier flossing experience. The device is dental floss that is configured in a loop that facilitates access to difficult-to-reach areas, particularly at the back of the mouth.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dental floss device. The device is comprised of a dental floss with a looped design that facilitates access to difficult-to-reach areas, particularly at the back of the mouth. The design also enables for improved grip and control during use. The floss of the device is waxed enabling it to remove plaque and debris. Additionally, the device is comprised of a circular body that encourages correct finger placement, thus enhancing maneuverability. Thus, the dental floss device provides a greatly improved flossing experience.

In one embodiment, the dental floss device comprises a dental floss. The floss is typically configured in a circular or looped shape but can be configured in any suitable shape as is known in the art. Typically, the floss comprises a wax coating that enables for removal of plaque and debris from between the teeth.

In one embodiment, the dental floss device also comprises a dispenser. The dispenser is generally configured in a cylindrical shape but can be configured in any suitable shape as is known in the art. Typically, the dispenser comprises an opening through which the floss is dispensed, a cap and a recessed portion. The recessed portion of the dispenser is smaller in diameter and enables the cap to fit so that it is flush with the rest of the dispenser.

In one embodiment, the dental floss device in accordance with the present invention can be produced in various colors, designs, patterns, etc., and feature logos, emblems and or designs, such as a distributor requests and/or a user desires.

In one embodiment, the dental floss device is manufactured of a high-density polyethylene (HDPE), or any other suitable materials as is known in the art. Any number of different types of materials can be used to make the dental floss device including but not limited to plastics, nylon, textile materials, etc.

In use, the user removes the cap of the dispenser. Further, the user pulls a piece of looped dental floss from the opening of the dispenser. Further, the user inserts both forefingers (i.e., at least one finger from each hand) into the looped dental floss to guide it and any other finger(s) pulls it away so that the floss is taught. Finally, the user can utilize the device to remove plaque and debris from between their teeth. Thus, the dental floss device provides a greatly improved flossing experience compared to ordinary methods. By utilizing the looped dental floss of the device, the user can more easily access the back of the mouth while flossing. Further, the looped design encourages correct finger placement while flossing.

It will also be appreciated that there are a number of additional add-on features that can be incorporated into the device and moreover, the dental floss device can take many different forms as is known in the art.

In yet another embodiment, the dental floss device comprises a plurality of indicia.

In yet another embodiment, a method of conveniently utilizing the dental floss device to floss the teeth is disclosed. The method includes the steps of providing a dental floss device comprising a plurality of individual looped dental flosses each featuring a wax coating, and a dispenser. The method also comprises removing the cap of the dispenser. Further, the method comprises pulling one individual looped dental floss from the opening of the dispenser. Further, the method comprises inserting both forefingers (i.e., at least one finger from each hand) into the looped dental floss to guide it and any other finger(s) pulls it away so that the floss is taught. Finally, the method comprises utilizing the device to remove plaque and debris from between the teeth.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the dental floss device of the present invention in use in accordance with the disclosed architecture;

FIG. 2 illustrates a perspective view of one embodiment of the dental floss device of the present invention showing all components of the device in accordance with the disclosed architecture;

FIG. 3 illustrates a perspective view of one embodiment of the dental floss device of the present invention showing a top down view of the floss, a ¾ view of the dispenser, and a use view of the floss in accordance with the disclosed architecture;

FIG. 4 illustrates multiple perspective views of one embodiment of the dental floss device of the present invention in accordance with the disclosed architecture; and

FIG. 5 illustrates a flowchart showing the method of conveniently utilizing the dental floss device to floss the teeth in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved flossing device. There is also a long felt need in the art for a dental floss device. Finally, there is a long felt need in the art for a dental floss device that enables a user to easily floss between teeth and between teeth at the back of their mouth.

The present invention, in one exemplary embodiment, is a novel dental floss device for removing plaque and debris from in between the teeth. The dental floss device comprises a dental floss that is configured in a looped (i.e., closed loop or band) or circular shape that facilitates access to difficult-to-reach areas, particularly at the back of the mouth. The floss comprises a thick ‘band’ (i.e., having a width from about 1 mm to about 4 mm) and features a wax coating that enables it to remove plaque and debris from in between the teeth. The circular design of the floss encourages correct finger placement, enhancing maneuverability. Thus, the dental floss device provides a greatly improved flossing experience. Accordingly, the device enables users to floss their teeth in a quick and easy manner. The present invention also includes a novel method of conveniently utilizing the dental floss device to floss the teeth. The method includes the steps of providing a dental floss device comprising a plurality of individual looped dental flosses each featuring a wax coating, and a dispenser. The method also comprises removing the cap of the dispenser. Further, the method comprises pulling one individual looped dental floss from the opening of the dispenser. Further, the method comprises inserting both forefingers (i.e., at least one finger from each hand) into the looped dental floss to guide it and any other finger(s) pulls it away so that the floss is taught. Finally, the method comprises utilizing the device to remove plaque and debris from between the teeth.

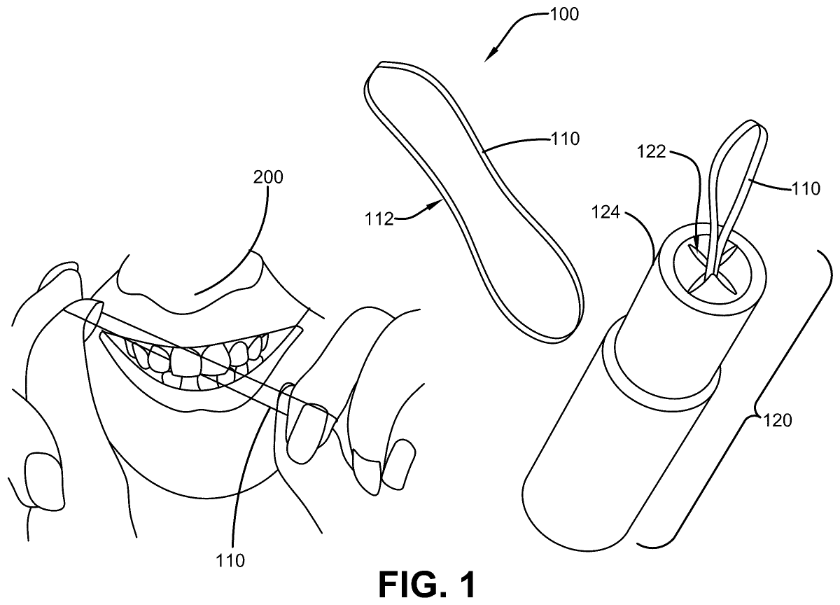

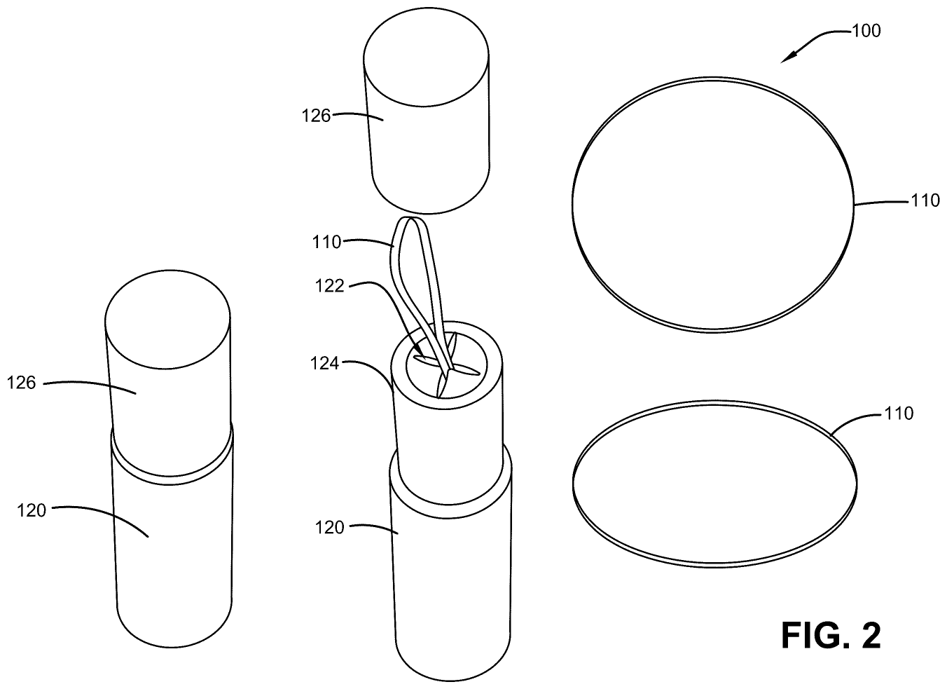

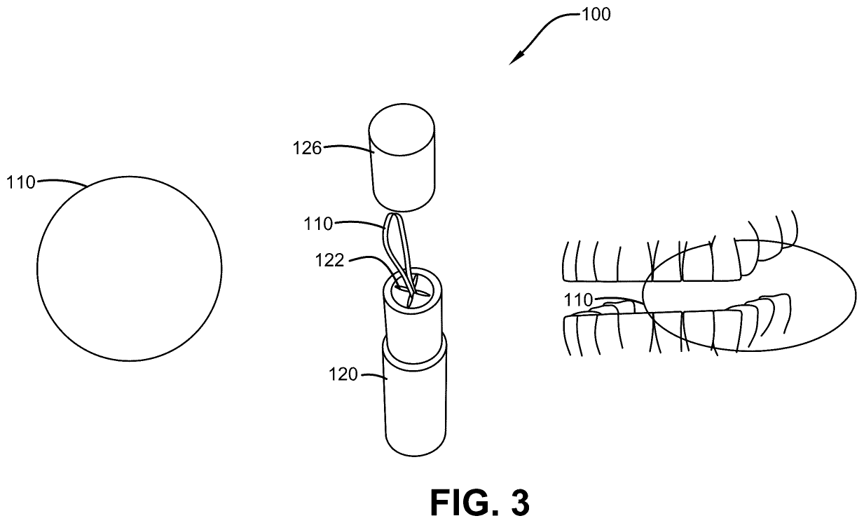

Referring initially to the drawings, FIGS. 1-4 illustrate multiple perspective views of one embodiment of the dental floss device 100 of the present invention. In the present embodiment, the dental floss device 100 is used to remove plaque and debris from in between the teeth. The dental floss device 100 comprises a dental floss or looped band 110 that is configured in a looped (i.e., closed loop or band) or circular shape that facilitates access to difficult-to-reach areas, particularly at the back of the mouth. The floss or looped band 110 having a ‘band’ width from about 1 mm to about 4 mm and features a wax coating 112 that enables the removal of plaque and debris from in between the teeth. In another embodiment, the floss or looped band 110 having a ‘band’ width from about 2 mm to about 3 mm. The circular design of the floss or looped band 110 encourages correct finger placement, enhancing maneuverability. Thus, the dental floss device 100 provides a greatly improved flossing experience.

As shown in FIGS. 1-4, the dental floss device 100 comprises a dental floss or looped band 110. The floss or looped band 110 is typically configured in a circular or looped shape but can be configured in any suitable shape as is known in the art. Typically, the floss or looped band 110 comprises a wax coating 112 that enables for removal of plaque and debris from between the teeth.

Further, the dental floss device 100 also comprises a dispenser 120. The dispenser 120 is generally configured in a cylindrical shape but can be configured in any suitable shape as is known in the art. Typically, the dispenser 120 comprises a top end opening or terminal end opening 122 through which the floss or looped band 110 is dispensed, a cap 126 and a recessed portion 124. The recessed portion 124 of the dispenser 120 is smaller in diameter and enables the cap 126 to fit so that it is flush with the rest of the dispenser 120.

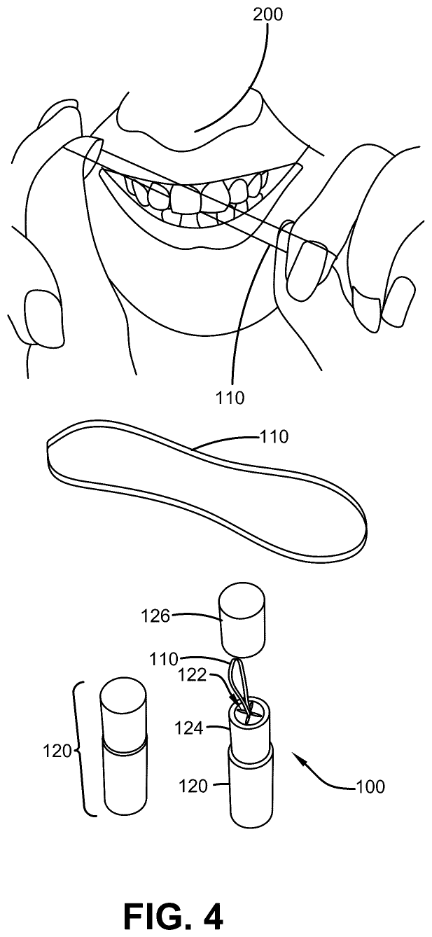

As shown in FIGS. 1 and 4, in use, the user 200 removes the cap 126 of the dispenser 120. Further, the user 200 pulls an individual looped dental floss or looped band 110 from the top end opening or terminal end opening 122 of the dispenser 120. Further, the user 200 inserts both forefingers (i.e., at least one finger from each hand) into the looped dental floss or looped band 110 to guide it and any other finger(s) pulls it away so that the floss or looped band 110 is taught. Finally, the user 200 can utilize the device 100 to remove plaque and debris from between their teeth. Thus, the dental floss device 100 provides a greatly improved flossing experience compared to ordinary methods. By utilizing the looped dental floss or looped band 110 of the device 100, the user 200 can more easily access the back of the mouth while flossing. Further, the looped design encourages correct finger placement while flossing.

As shown in FIG. 4, the dental floss device 100 in accordance with the present invention can be produced in various colors, designs, patterns, etc., and feature logos, emblems and or designs, such as a distributor requests and/or a user 200 desires.

In one embodiment, the dental floss device 100 is manufactured of a high-density polyethylene (HDPE), or any other suitable materials as is known in the art. Any number of different types of materials can be used to make the dental floss device 100 including but not limited to nylon, textile materials, heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc.

In yet another embodiment, the dental floss device 100 comprises a plurality of indicia 400. The dispenser 120 of the device 100 may include advertising, a trademark, or other letters, designs, or characters, printed, painted, stamped, or integrated into the dispenser 120, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be floss, teeth, or brand related.

It will also be appreciated that there are a number of additional add-on features that can be incorporated into the device 100 and moreover, the dental floss device 100 can take many different forms as is known in the art.

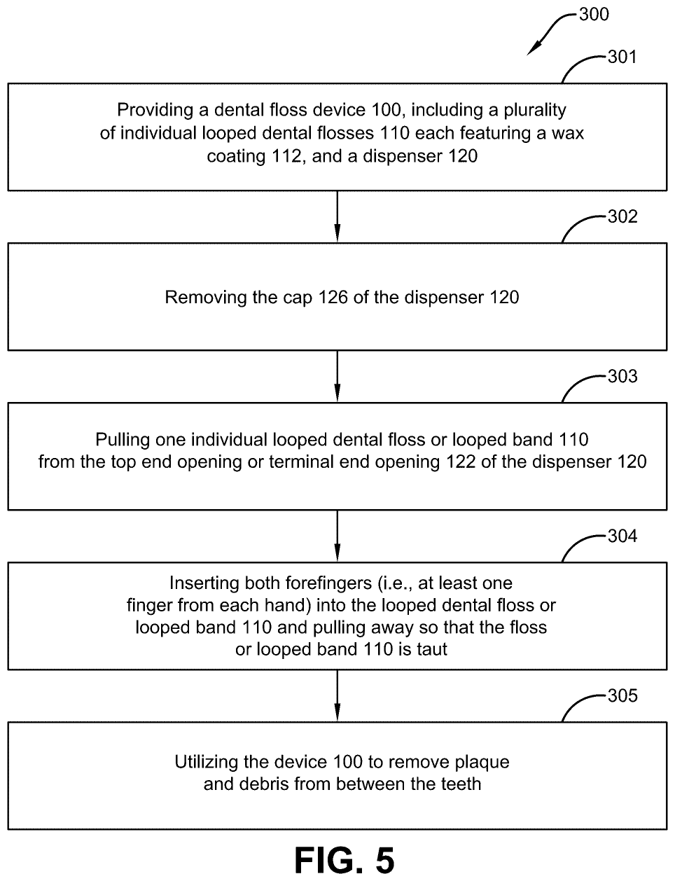

FIG. 5 illustrates a flowchart of the method 300 of conveniently utilizing the dental floss device 100 to floss the teeth. The method 300 includes the steps of at 301, providing a dental floss device 100, including a plurality of individual looped dental flosses 110 each featuring a wax coating 112, and a dispenser 120. The method 300 also comprises at 302, removing the cap 126 of the dispenser 120. Further, the method 300 comprises at 303, pulling one individual looped dental floss or looped band 110 from the top end opening or terminal end opening 122 of the dispenser 120. Further, the method 300 comprises at 304, inserting both forefingers (i.e., at least one finger from each hand) into the looped dental floss or looped band 110 to guide it and any other finger(s) pulls it away so that the floss or looped band 110 is taught. Finally, the method 300 comprises at 305, utilizing the device 100 to remove plaque and debris from between the teeth.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “dental floss device”, “flossing device”, “dental device”, and “device” are interchangeable and refer to the dental floss device 100 of the present invention.

Notwithstanding the forgoing, the dental floss device 100 of the present invention can be of any suitable size and configuration as is known in the art without affecting the overall concept of the invention, provided that it accomplishes the above stated objectives. One of ordinary skill in the art will appreciate that the dental floss device 100 as shown in FIGS. 1-4 is for illustrative purposes only, and that many other sizes and shapes of the dental floss device 100 are well within the scope of the present disclosure. Although the dimensions of the dental floss device 100 are important design parameters for user convenience, the dental floss device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dental floss device for removing plaque and debris from in between teeth comprising:
a dental floss device;
a plurality of looped dental flosses; and
a dispenser;
wherein each of said plurality of looped dental flosses having a closed loop shape;
wherein said closed loop shape comprising a circular band; and
further wherein each of said plurality of looped dental flosses dispensable individually from said dispenser.

2. The dental floss device for removing plaque and debris from in between teeth of claim 1, wherein said circular band having a width from 1 mm to 4 mm.

3. The dental floss device for removing plaque and debris from in between teeth of claim 1, wherein said circular band having a width from 2 mm to 3 mm.

4. The dental floss device for removing plaque and debris from in between teeth of claim 2, wherein said circular band having a wax coating.

5. The dental floss device for removing plaque and debris from in between teeth of claim 4, wherein said dispenser having a cylindrical shape.

6. The dental floss device for removing plaque and debris from in between teeth of claim 5, wherein said dispenser having a top end opening for accessing an individual one of said plurality of looped dental flosses.

7. The dental floss device for removing plaque and debris from in between teeth of claim 6, wherein said plurality of looped dental flosses having a material of a high-density polyethylene (HDPE).

8. The dental floss device for removing plaque and debris from in between teeth of claim 6, wherein said plurality of looped dental flosses having a material selected from the group consisting of a nylon, a heat-sealable polymer, a polypropylene, and an acrylonitrile-butadiene-styrene (ABS).

9. The dental floss device for removing plaque and debris from in between teeth of claim 6, wherein said plurality of looped dental flosses having a material selected from the group consisting of an acrylic, a polycarbonate, a polyethylene, a polyethylene terephthalate, a polyvinyl chloride, and a polystyrene.

10. A dental floss device for removing plaque and debris from in between teeth comprising:
a dental floss device;
a plurality of looped dental flosses; and
a dispenser;
wherein each of said plurality of looped dental flosses having a closed loop shape;
wherein said closed loop shape comprising a circular band;
wherein each of said plurality of looped dental flosses dispensable individually from said dispenser;
wherein said circular band having a width from 1 mm to 4 mm; and
further wherein said dispenser having a top end opening for accessing an individual one of said plurality of looped dental flosses.

11. The dental floss device for removing plaque and debris from in between teeth of claim 10, wherein said circular band having a width from 2 mm to 3 mm.

12. The dental floss device for removing plaque and debris from in between teeth of claim 11, wherein said circular band having a wax coating.

13. The dental floss device for removing plaque and debris from in between teeth of claim 12, wherein said dispenser having a cylindrical shape.

14. The dental floss device for removing plaque and debris from in between teeth of claim 13, wherein said plurality of looped dental flosses having a material of a high-density polyethylene (HDPE).

15. The dental floss device for removing plaque and debris from in between teeth of claim 13, wherein said plurality of looped dental flosses having a material selected from the group consisting of a nylon, a heat-sealable polymer, a polypropylene, and an acrylonitrile-butadiene-styrene (ABS).

16. The dental floss device for removing plaque and debris from in between teeth of claim 13, wherein said plurality of looped dental flosses having a material selected from the group consisting of an acrylic, a polycarbonate, a polyethylene, a polyethylene terephthalate, a polyvinyl chloride, and a polystyrene.

17. A method of using dental floss for removing plaque and debris from in between teeth, the method comprising the steps of:
providing a dental floss device, a plurality of looped dental flosses, and a dispenser, wherein each of said plurality of looped dental flosses having a closed loop shape, further wherein said closed loop shape comprising a circular band;
pulling each of said plurality of looped dental flosses individually from said dispenser;
inserting at least one finger from each hand into said closed loop of one of said plurality of looped dental flosses;
pulling said one of said plurality of looped dental flosses taught with said at least one finger from each hand; and
inserting a portion of said one of said plurality of looped flosses in between teeth for removing plaque and debris.

18. The method of using dental floss for removing plaque and debris from in between teeth of claim 17, wherein said circular band having a width from 1 mm to 4 mm, and further wherein said dispenser having a top end opening for accessing an individual one of said plurality of looped dental flosses.

19. The method of using dental floss for removing plaque and debris from in between teeth claim 18, wherein said circular band having a wax coating.

20. The method of using dental floss for removing plaque and debris from in between teeth of claim 19, wherein said plurality of looped dental flosses having a material selected from the group consisting of an acrylic, a polycarbonate, a polyethylene, a polyethylene terephthalate, a polyvinyl chloride, and a polystyrene.
